(19) United States
(12) Patent Application Publication
(10) Pub. No.: US 2013/0226934 A1
(43) Pub. Date: Aug. 29, 2013

(54) Efficient Electronic Document Ranking For Internet Resources in Sub-linear Time

(71) Applicants: Michael A. Brautbar, Philadelphia, PA (US); Christian Herwarth Borgs, Boston, MA (US); Jennifer Tour Chayes, Boston, MA (US); Shanghua Teng, Los Angeles, CA (US)

(72) Inventors: Michael A. Brautbar, Philadelphia, PA (US); Christian Herwarth Borgs, Boston, MA (US); Jennifer Tour Chayes, Boston, MA (US); Shanghua Teng, Los Angeles, CA (US)

(73) Assignee: MICROSOFT CORPORATION, Redmond, WA (US)

(21) Appl. No.: 13/405,419

(22) Filed: Feb. 27, 2012

(51) Int. Cl. G06F 17/30; G06Q 30/02

(52) U.S. Cl. 707/748; 705/14.49; 707/E17.008

(57) ABSTRACT

The subject disclosure is directed towards ranking electronic documents in sub-linear time complexity. An advertising provider may perform such a ranking in order to identify one or more electronic document to advertise a product or service. A ranking mechanism may execute a number of random walks around the Internet by navigating the electronic documents via embedded links from a starting document and an ending document that are within a pre-determined distance. After finishing the random walks, an estimate of rank contribution information associated with each electronic document is provided. The estimated rank contribution information is used to determine an exposure level with respect to a network for one or more of the electronic documents. The exposure value of an example electronic document may correspond to a ranking value that may be computed using a sample of the rank contribution information related to that document.

### BACKGROUND

Network analysis techniques may be applied to small to large networks. Link analysis techniques constitute a subset of the network analysis techniques and involve the examination of relationships between electronic documents. Several Internet/web search ranking algorithms use link-based centrality metrics, such as PageRank®. The link analysis techniques may also be applicable in information science and communication science for the purpose of understanding and extracting information from the structure of collections of electronic documents. For example, the analysis may relate to the interlinking (e.g., in-bound linking and out-bound linking) between political websites/blogs or electronic entities on a social/informational network.

Some of these Internet search ranking algorithms capture a probability that an electronic document, such as a webpage, may be visited by a random web user that explores the Internet using a random walk, where at each step, the random web user navigates to another webpage via an embedded link or restarts his/her search from a randomly chosen webpage with some constant probability (often referred to as the teleportation constant or termination probability). These algorithms may also capture a personalized behavior of a user that always returns to an original webpage whenever a restart occurs. Conventional methods for evaluating and ranking web pages often rely on a costly series of matrix multiplications and other operations that require a significant amount of time. In terms of time complexity, the conventional methods cannot run better than linear time as a function of input size without making certain assumptions concerning the configuration of the Internet, such as by setting a maximum out-degree from a web page.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a ranking mechanism for electronic documents associated with Internet resources in sub-linear time. In one aspect, the ranking mechanism produces ranking values for electronic documents (e.g., web pages, social network users, status update publishers and/or the like) in sub-linear time complexity, such as for an advertising provider. The ranking values may be in the form of in-degrees, which may be computed based on a number of in-bound links. In one aspect, the ranking mechanism uses the in-degrees to compute exposure levels for at least some of the electronic documents.

In one aspect, exposure level determinations may be performed by navigating a plurality of nodes, such as social network electronic entities, via out-bound links in order to estimate in-degrees for each node. Each in-degree estimation may involve a pre-determined number of traversals through a (web) graph that either return to a node after length steps or a terminating step. In one aspect, the length may refer to a pre-defined distance between a first node and a second node. Furthermore, the terminating step may refer to stopping the traversal in response to the terminating/teleportation probability.

After estimating the in-degrees for each node and determining a highest or maximum in-degree in the graph, a set of nodes are selected to expose an advertisement to a network, such as a social and/or informational network. In one aspect, the ranking mechanism identifies the set of nodes having in-degrees that exceed an in-degree threshold. In one aspect, the ranking mechanism identifies the set of nodes having a highest in-degree sum amongst the plurality of nodes. In another aspect, the ranking mechanism identifies the set of nodes having a highest in-degree coverage amongst the plurality of nodes.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an example system for ranking electronic documents for internet resources according to one example implementation.

FIG. 2 is a flow diagram illustrating an example system for ranking electronic documents for internet resources according to one example implementation.

FIG. 3 is a flow diagram illustrating example steps for generating personalized ranking information corresponding to electronic entities according to one example implementation.

FIG. 4 is a flow diagram illustrating example steps for selecting one or more electronic entities based on exposure level according to one example implementation.

FIG. 5 is a block diagram representing example non-limiting networked environments in which various embodiments described herein can be implemented.

FIG. 6 is a block diagram representing an example non-limiting computing system or operating environment in which one or more aspects of various embodiments described herein can be implemented.

### DETAILED DESCRIPTION

Various aspects of the technology described herein are generally directed towards efficient electronic document ranking for Internet resources in sub-linear time. According to one example implementation, a ranking mechanism may compute in-degrees within an acceptable approximation factor (e.g., range), in sub-linear time, for electronic entities of a network resource, such as a social and/or informational network. Each in-degree computation may involve a pre-defined series of random walk simulations that either return to a node after length steps or a terminating step. The approximation factor may include a multiplicative error and an additive error. The ranking mechanism may determine exposure levels for the electronic entities that have at least a threshold number of in-bound links. An example exposure level in general may refer to an extent that a publication (e.g., a positing, a status update and/or the like) by a corresponding electronic entity is viewed by other electronic entities within the network resource. These exposure levels may be used by an advertising provider to identify a set of electronic entities that maximize exposure within the social and/or informational network.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and electronic document technology in general.

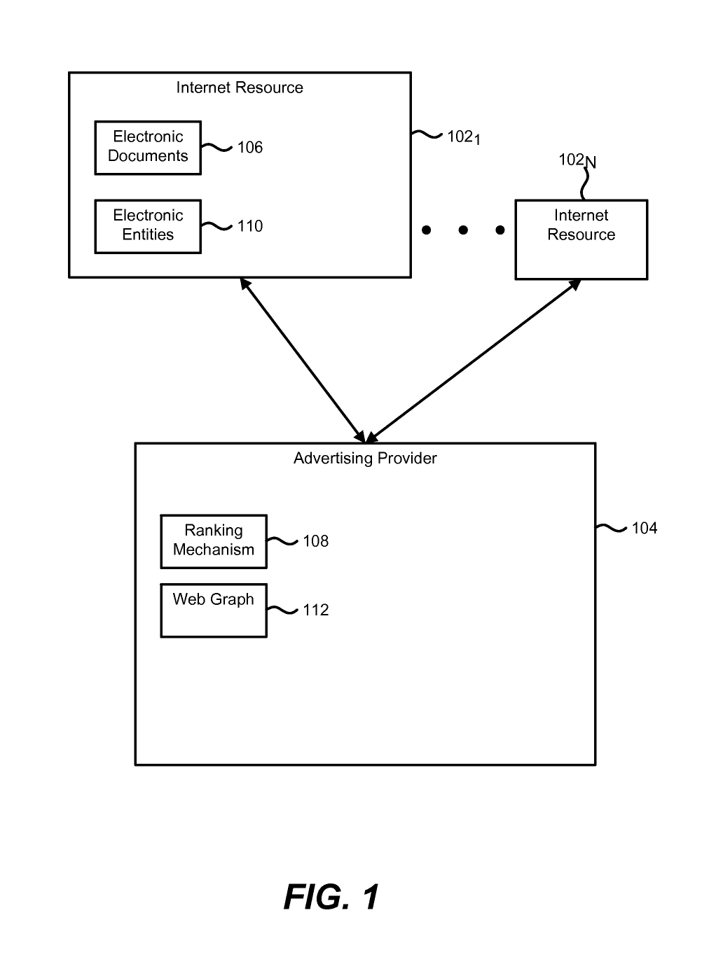

FIG. 1 is a block diagram illustrating an example system for ranking electronic documents for Internet resources according to one example implementation. Components of the example system may include a plurality of Internet resources 102 (hereinafter referred to as the Internet resources 102) and an advertising provider 104.

In one example implementation, the advertising provider 104 communicates data related to various ones of electronic documents 106 stored within the Internet resources 102 and vice versa via wired and/or wireless data communication technology. The Internet resources 102 may include various web service and/or data providers, such as cloud computing databases, news websites, popular communication tools, social networks and/or the like. The search engine provider 104 (e.g., MICROSOFT Bing®) may use a ranking mechanism 108 to generate ranking values for the electronic documents 106 in order to identify one or more electronic documents of interest.

In one example implementation, the ranking mechanism 108 may perform the ranking value generation in two stages. In a first stage, the ranking mechanism 108 may produce rank contribution values for each of the electronic documents 106. When a first electronic document includes an embedded link through which a user may navigate to the second electronic document, the rank contribution value of the first electronic document may be a ranking value estimate of the second electronic document with respect to the first electronic document. The ranking mechanism 108 may compute rank contribution value on each other linked electronic document. The first electronic document may correspond to a set of rank contribution values for a set of linked electronic documents.

The ranking mechanism 108 may proceed to repeat the rank contribution value computation technique for each remaining electronic document of the electronic document 106. As described herein, the ranking mechanism 108 may compute the set of rank contribution values using truncated random walks. In a second stage, the ranking mechanism 108 may estimate the ranking value for the first electronic document by extracting a sample (e.g., a sample of chunks) using one or more rank contribution values from one or more electronic documents that link to the first electronic document. The ranking mechanism 108 may repeat this sampling technique for each other electronic document.

According to one example implementation, the ranking mechanism 108 may compute the (personalized) ranking values corresponding to exposure levels of electronic entities 110. The electronic entities 110 may include users (e.g., members) of a social and/or information network or online community. For example, the ranking mechanism 108 may determine the exposure level based on a number of in-bound links associated with a particular electronic entity, such as a number of people following electronic publications of another person. The exposure level of the particular electronic entity may correspond to a number of neighbors (e.g., friends, network connections, followers and/or the like) having a particular commercial product divided by the number of in-bound links. Hence, the exposure level may indicate a likelihood of viewing a neighbor publication promoting the particular commercial product. The more neighbors that submit various publications (e.g., wall postings, status updates and/or forum posts and/or the like), the particular electronic entity is more likely to encounter an advertisement.

The ranking mechanism 108 may use a sub-linear personalized ranking technique to select one or more of the electronic entities 110 having at least a pre-defined exposure level, such as a minimum in-degree threshold that is within an acceptable range of a maximum in-degree within a web graph 112. Alternatively, the ranking mechanism 108 may employ another pre-defined exposure level based on an indicator function for having at least one in-bound link. In one alternative implementation, the ranking mechanism 108 applies the sub-linear personalized ranking technique to select one or more of the electronic entities 110 having at least a pre-defined set size of in-bound links. The set comprising each selected electronic entity may constitute an estimated optimal group to publish an endorsement of a particular product in order to maximize a likelihood that such an endorsement is viewed by as many neighbor entities as possible.

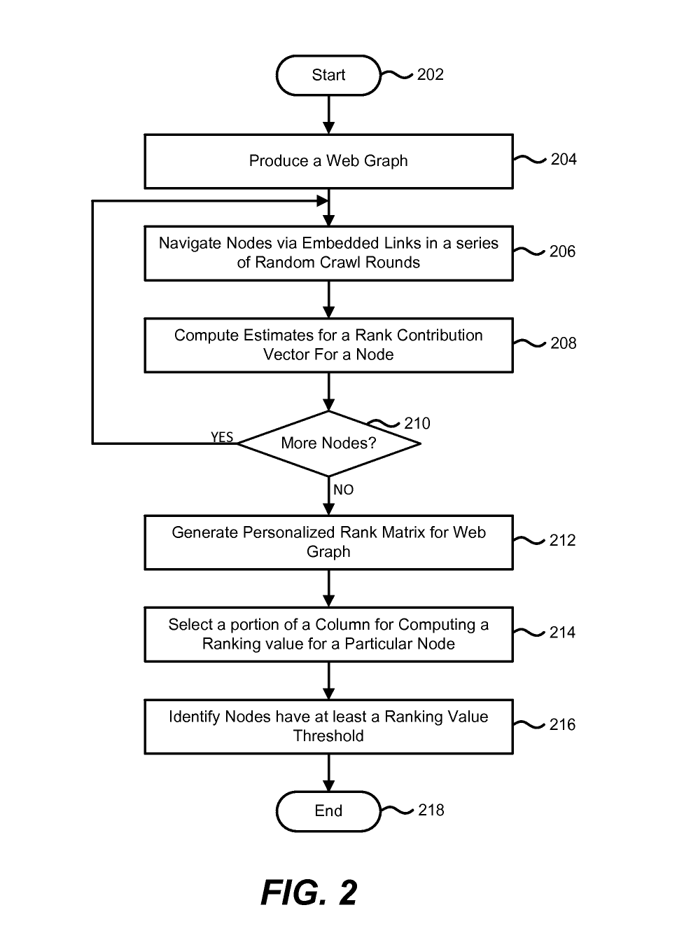

FIG. 2 is a block diagram illustrating example steps for a sub-linear technique for generating personalized ranking information corresponding to electronic entities according to one example implementation. One or more of the example steps may be performed by the ranking mechanism 108. The example steps commence at step 202 and proceed to step 204 at which the ranking mechanism 108 produces a web graph (e.g., the web graph 112 of FIG. 1) comprising n nodes that may represent a plurality of users of a social and/or informational network according to one example implementation. As described herein, the web graph may embody the social and/or informational network such that each node represents an electronic entity and/or a set of electronic documents.

An organizer/owner of such a network may provide an example user (e.g., a registered member) with the set of electronic documents on which to publish various information, such as status updates, (wall) postings, goods and/or service provider reviews including advertisements and/or the like. Other users may access and view the set of electronic documents under certain conditions. For example, the other users may follow the publications of the example user in a one-directional out-bound link. As another example, the other users may be network connections/friends of the example user and may view the publications in an update feed along with other publications, such as network updates from other network connections. Hence, the other users contribute values (e.g., rank contribution values) to a personalized ranking information (e.g., a ranking value) associated with the example user. For example, each other user may contribute a binary value of one (1) representing the presence of an in-bound link to the example user's set of electronic documents. The other users, alternatively, may contribute fractional values to the personalized ranking information based on the presence of the in-bound link.

Step 206 refers to navigating nodes within the web graph via embedded links in a series of random walk rounds. In one example implementation, step 206 may execute the series of random walk rounds for a particular starting node (e.g., electronic document or electronic entity) and sets an upper-bound for a length of each random walk round in order to facilitate rank contribution value estimation within an appropriate approximation range. The ranking mechanism 108, as an example, may perform

$$\frac{1}{ɛ {ρ}^{2}} * 8 log ( n )$$

random walk rounds in which each round simulates a random walk across a set of nodes, with termination probability of α, for at most the upper-bound length. At each node in the random walk including the starting node, the ranking mechanism 108 may perform a jump query (e.g., a “termination” step) at the probability α and perform a (random) crawl query at a probability (1−α). During the crawl query, the ranking mechanism 108 selects an out-bound link and navigates to a connected node. During the jump query, the ranking mechanism 108 labels a last node visited as an ending node and returns to a random node in the web graph, such as the starting node. A distance between the starting node and the ending node may not exceed the upper-bounded, pre-defined length.

Step 208 is directed to computing estimates of a rank contribution vector associated with the starting node. According to one example implementation, each member of the rank contribution vector may refer to a node in the webgraph. Each node having a non-negative value in the rank contribution vector may refer to an electronic entity to which the starting node may link. For example, the rank contribution vector may include non-negative values for each ending node resulting from the random walk rounds during step 206. Each non-negative value may represent an acceptable approximation of a true value that the starting node contributes to a ranking value of the ending node. An example rank contribution value from a node v to node j may be equal to a probability that a traversal across the web graph, starting at node v and terminating with a probability α, arrives at node j immediately prior to termination.

In order to ensure that the execution of the random walk rounds satisfies a sub-linear time complexity, a total number of queries performed, as well as running time, may be characterized as the following expression:

$$O ( \frac{log ( n ) log ( {ε}^{- 1} )}{ɛ {ρ}^{2} {log}_{1 / 2} ( 1 - α )} )$$

The terms ε and ρ may represent an additive approximation and a multiplicative approximation, respectively, of a true rank contribution value from the starting node to the ending node. When combined, these terms produce an estimate of the actual rank contribution value within the acceptable approximation range. In order generate such an estimate within sub-linear time, the upper-bound length may be pre-defined as the following expression:

$${log}_{( 1 - α )} ( \frac{ɛ}{1 - ρ} )$$

Step 210 determines whether there are more nodes in the webgraph to traverse and produce values for a rank contribution vector. If there are no more nodes, step 210 proceeds to step 212. If there are more nodes, step 210 returns to step 206 and performs the series of random crawl rounds for another node in the web graph. In one example implementation, the ranking mechanism 108 determines a minimum number of nodes to examine in order to estimate a personalized ranking value for a node j. According to such an implementation, step 210 returns to step 206 if there more nodes to sample.

In order to produce values for each entry in a row, step 206 and step 208 may be performed with at most a two multiplicative approximation and at

$$( ρ = \frac{1}{2} )$$

most

$$\frac{ɛ}{2}$$

additive error by executing at least a number of jump and/or random crawl queries in accordance with the following:

$$O ( \frac{log ( n ) log ( {ε}^{- 1} )}{ɛ} )$$

Step 212 refers to generating a personalized rank matrix for the webgraph. The personalized rank matrix may comprise an aggregation of the rank contribution vectors for one or more of the nodes within the webgraph. For example, the rank contribution vector from node v to nodes 1 . . . n may form a row of the personalized rank matrix at position v. Each value in the row includes a fraction of the number of random walk rounds and a summation of the row entries may equal one (1). Hence, a column at position j may include rank contribution values from nodes 1 . . . n to node j, which may be transformed into the ranking value for node j.

Step 214 refers to selecting a portion of the personalized rank matrix column to compute a ranking value estimate for each node. The ranking value estimate may be used to represent an exposure level for the node, as described herein. After executing one or more computations on one or more column entries, the ranking mechanism 108 may produce the ranking value estimate as a sum of such column entries according to one example implementation. In another implementation, the ranking mechanism 108 may partition each matrix column into chunks where column entries in each chunk are between ε and 2ε in value. The ranking mechanism 108 may extract a sample of these chunks to estimate the ranking value (e.g., the global ranking value) of a particular node. Using such a sample, the ranking mechanism 108 generate the global ranking value estimate within an approximation factor that corresponds to an additive error and/or a multiplicative error as described further below.

In one example implementation, the ranking mechanism 108 may filter out any chunk having column entry values that do not correspond to an additive approximation error of ε=Δ/4n where a ranking value threshold is labeled Δ (delta) such that each ranking value ranges from α≦Δ≦n. The ranking value threshold may be a pre-defined minimum rank for a global ranking value estimate for the particular node. By identifying chunks of the personalized rank matrix column that may have entries with a rank contribution value in excess of the ranking value threshold, the ranking mechanism 108 improves the global ranking value estimate accuracy. As a result, the sample only includes clunks that contribute at least a quarter to the global ranking value estimate. Step 216 is directed to identifying nodes having at least the global ranking value threshold. Based on the value labeled Δ (delta), the ranking mechanism 108 may use the personalized rank matrix to identify nodes with the ranking value of at least Δ according to one example implementation.

Each chunk associated with the column j where a sum of column entries is equal to at least

$$\frac{Δ}{2 log ( n )}$$

may constitute an acceptable approximation of the personalized ranking value and may be referred to as a “heavy chunk.” Since the entries in each heavy chunk are substantially homogeneous, approximating the sum reduces to the problem of approximating a number of entries. Approximating the sizes of all heavy chunks corresponding to additive approximation factor ε may be performing using an order of

$$O ( \frac{n}{Δ } ɛ )$$

number of jump queries. In one example implementation, executing a greater number of jump queries may render the ranking value approximation as computationally expensive.

For each node j, the ranking mechanism 108 computes the global ranking value estimate, over all values of εₜ, based on a sum of the sizes of the heavy chunks parameterized by εₜ in which each size may be multiplied by a normalizing factor

$$\frac{Δ}{{ɛ}_{t} 2 {log}^{2} ( n )} .$$

The ranking mechanism 108 identifies each node j having a column sum estimate greater than or equal to

$$\frac{Δ}{4}$$

and disregards any node with a column sum estimate smaller than

$$\frac{Δ}{c}$$

where c is pre-defined constant independent of column size, according to one example implementation. The ranking value estimates may be used to compute exposure levels for nodes j as described herein. The example steps terminate at step 216.

In another example implementation, given a directed graph with only direct access to out-bound links of electronic document and represented as adjacency lists, the ranking mechanism 108 desires to find electronic documents with a high in-degree. The ranking mechanism 108 examines the adjacency lists in matrix form, extracts a row at random using a jump query, and scans the adjacency lists, using crawl queries, for out-bound links from an electronic document associated with the row. After repeating the jump and crawl queries for certain randomly chosen rows corresponding to the adjacency lists, the ranking mechanism 108 estimates an in-degree for the electronic documents.

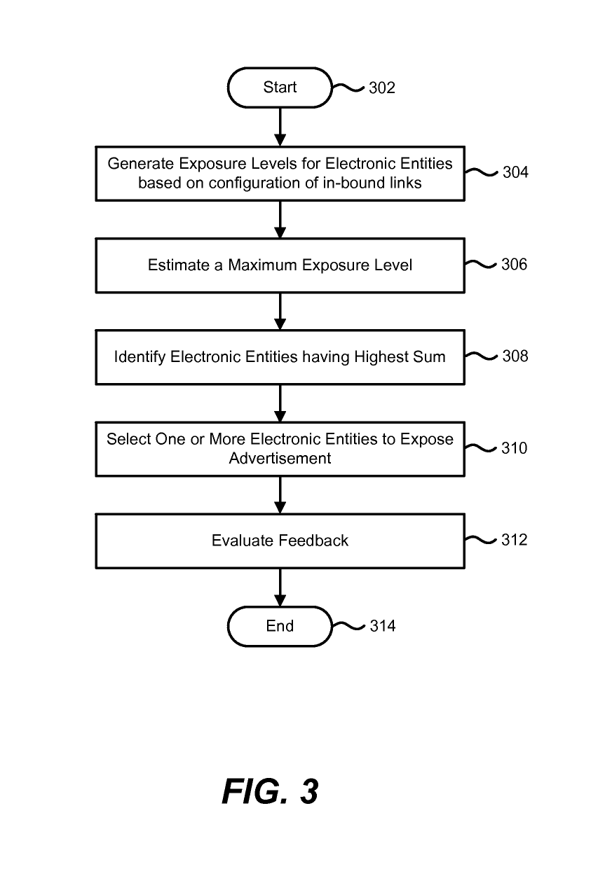

FIG. 3 is a flow diagram illustrating example steps for identifying electronic entities having at least a pre-defined in-degree according to one example implementation. One or more of the example steps may be performed by the ranking mechanism 108. The example steps commence at step 302 and proceed to step 304 at which the ranking mechanism 108 generates an exposure level for each electronic entity based on a configuration of in-bound links. Such a configuration may refer to all of the in-bound links or a portion thereof. For instance, the configuration may refer to a set of neighbor entities (e.g., social network connections) that own a particular product and published a visible advertisement (e.g., an endorsement). In one example implementation, the ranking mechanism 108 computes an exposure level by dividing a size of the set of neighbor entities and a total number of in-bound links.

Given a directed graph G and a pre-defined number k, a combined set of k nodes may correspond to a highest total exposure level in the graph G. The exposure level may be a pre-defined probability p times the number of neighbors that already have the product. Thus, if k friends of node v post a message about the new product on an online profile, then v is k times more likely to be exposed to that message when browsing his/her own online profile. Hence, the set of k nodes with a highest in-degree sum may maximize exposure to an advertisement within the graph, as described herein.

Step 306 refers to estimating a maximum exposure level amongst the electronic entities and determining a threshold exposure level for sum approximation. By halving a previous maximum exposure level estimate and searching the graph for entities (e.g., nodes) having at least a current maximum exposure level during each iteration, the ranking mechanism 108 determines a probable estimate for the maximum exposure level when the graph search identifies a first electronic entity having the current estimate. Each graph search involves a number of jump and crawl queries in order to produce a rank contribution row that comprises values estimating row entries up to a 1+ρ multiplicative approximation plus ε additive error. The estimation technique iterations may result in a logarithmically progressing overhead comprising the number of queries performed as well as runtime operational costs. Thus, a time complexity of the number of jump and crawl queries including runtime may be O(m/Δ).

Step 308 is directed to identifying a set of electronic entities having a highest sum amongst all of the electronic entities. In one example implementation, the set of electronic entities may refer to k electronic entities having a highest in-degree sum within an acceptable approximation range. The ranking mechanism 108 sets the threshold exposure level to Δ/k which results in a combined query time and runtime complexity of O (km/Δ). Similar to the personalized ranking value approximation described with respect to FIG. 2, electronic entities having an in-degree smaller than

$$\frac{Δ}{2 k}$$

may be ignored to ensure a constant approximation since such entities may contribute at most

$$\frac{Δ}{2}$$

to the exposure level sum of the highest k in-degree nodes. Each electronic entity having with in-degree exceeding

$$\frac{Δ}{2 k}$$

may be approximated between a factor of at least 1/c of a true exposure level and c times the true exposure value for some constant c independent of graph size.

Step 310 refers to a selection of one or more electronic entities to expose an advertisement. The ranking mechanism 108 may select the k electronic entities or a portion thereof according to one example implementation. Step 312 represents an evaluation of feedback regarding the advertisement. As one or more electronic purchase a product being endorsed by the advertisement, the ranking mechanism 108 may examine statistical information related to effectiveness of the advertisement. Step 314 terminates the example steps illustrated in FIG. 3.

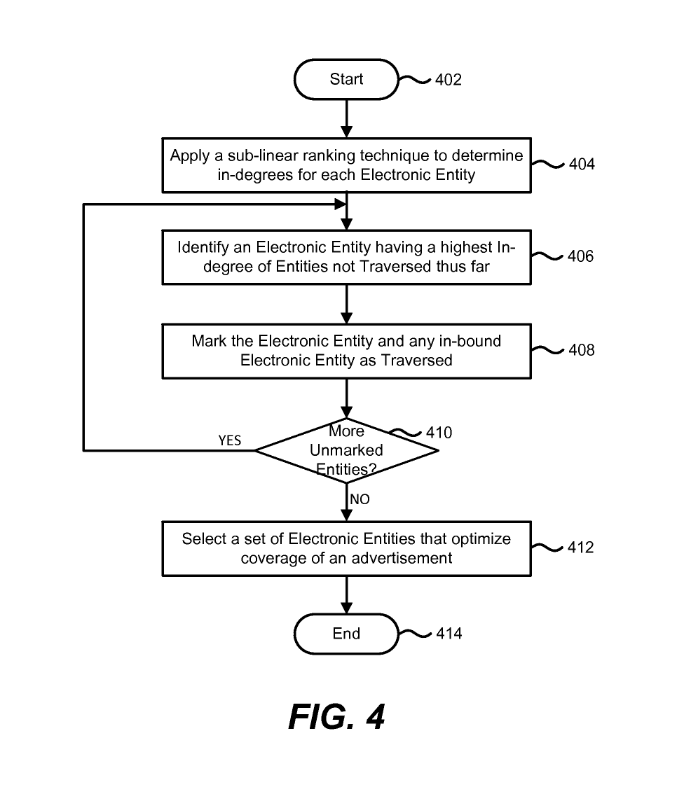

FIG. 4 is a flow diagram illustrating example steps for selecting one or more electronic entities based on exposure level according to one example implementation. One or more of the example steps may be performed by the ranking mechanism 108. The example steps commence at step 402 and proceed to step 404 at which a sub-linear technique is applied to a graph (G), such as the web graph 112 of FIG. 1, for the purpose of determining in-degrees for electronic entities. The graph may represent each electronic entity as a node connected to one or more other nodes via edges consisting of in-bound links and/or out-bound links. The ranking mechanism 108 may use the sub-linear technique to simulate random walks amongst the electronic entities via out-bound/in-bound links until a termination step or a pre-defined length, when the sub-linear technique returns to an original, starting electronic entity or randomly selects another electronic entity for a next random walk. After traversing at least a portion of the links from a particular starting electronic entity, the sub-linear technique produces an out-bound adjacency list (e.g., represented in the form of a vector) and/or an in-bound adjacency list (e.g., represented in the form of a vector) between the particular starting electronic entity and other electronic entity in the graph.

For each adjacency list, the ranking mechanism 108 performs various computations, including random crawl and jump queries. Adjacency lists from various electronic entities may be combined to estimate a number of in-bound links, or in-degree, to the particular starting electronic entity. In one example implementation, the sub-linear technique determines a (sample) number of adjacency lists to generate in order to estimate the particular starting electronic entity in-degree within an acceptable approximation factor. The ranking mechanism 108 extracts the number of adjacency lists and computes the in-degree for each electronic entity as well as a maximum in-degree for the entire graph. Using a sub-linear number of jump and crawls queries, the ranking mechanism 108 achieves a constant factor approximation of a set of k electronic entities having the maximum or optimal coverage, which may be a factor of

$$( 1 - \frac{1}{ɛ} )$$

from optimal.

Step 406 is directed to identifying an electronic entity having a highest in-degree with respect to entities not traversed thus far. The ranking mechanism 108 identifies an electronic entity such that the size of the set of in-bound links to un-traversed neighbor entities is maximized. Instead of finding the electronic entity of highest in-degree, the ranking mechanism 108 identifies the electronic entity that is at least a factor of 1/c of the maximum in-degree (d*) with respect to the electronic entities not covered/traversed thus far, according to one example implementation. Hence, such an implementation provides an

$$\frac{1}{c} ( 1 - \frac{1}{ɛ} )$$

approximation for some constant c independent of the graph size. Furthermore, any electronic entity with in-degree less than

$$\frac{{d}^{*}}{2 k} ,$$

where d* is the maximum in-degree in the graph, may be ignored to ensure constant approximation.

Before a jump or crawl query traverses to an electronic entity, the ranking mechanism 108 determines whether that electronic entity is already marked as traversed or covered. According to one example implementation, such a determination may be accomplished with an out-degree based logarithmic overhead by representing the marked entities in a binary search tree. The ranking mechanism 108 may also guarantee that a jump query only return an electronic entity having at least one non-marked electronic entity amongst the out-bound links.

Step 408 refers to marking the electronic entity identified by step 406 as traversed. For each iteration, the ranking mechanism 108 searches the graph and finds a particular electronic entity having a highest in-degree between Δ and d* (a maximum in-degree of entities in the graph). Upon receiving an adjacency list corresponding to in-bound links to the particular electronic entity, the ranking mechanism 108 designates/marks all electronic entities from that list as covered. According to one example implementation, the ranking mechanism 108 may insert these electronic entities into the binary search tree to facilitate a search for marked entities at a next iteration.

Step 410 refers to a determination as to whether there are more unmarked entities to traverse. For example, step 410 may examine the graph and ascertain that there are no more unmarked entities having at least one uncovered electronic entity and may proceed to step 412 implying that the set of electronic entities provide a maximum exposure level. As another example, step 410 may proceed to step 412 if step 406 to step 408 have successively identified the set of k electronic entities having a highest in-degree coverage within the graph. Otherwise, step 410 returns to step 406 unless the maximum in-degree with respect to unmarked entities is less than

$$Δ = \frac{{d}^{*}}{2 k} ,$$

in which instance step 410 proceeds to step 412.

Step 412 refers to selecting the set of electronic entities that maximize exposure in the form of network coverage. The set of electronic entities may have an in-bound link configuration with an optimal number of connected electronic entities. The ranking mechanism 108 may select at least one of the optimal set k of electronic entities to maximize a number of electronic entities that have at least one out-bound linked neighbor entity with the product. Assuming that the ranking mechanism 108 may access in-bound link adjacency lists and out-bound link adjacency lists, identifying a solution set with parameter k may involve only k in-bound link adjacency list inquires. Hence, an optimal solution set of k electronic entities with respect to coverage may be achieved despite limited access to the in-bound link adjacency lists.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

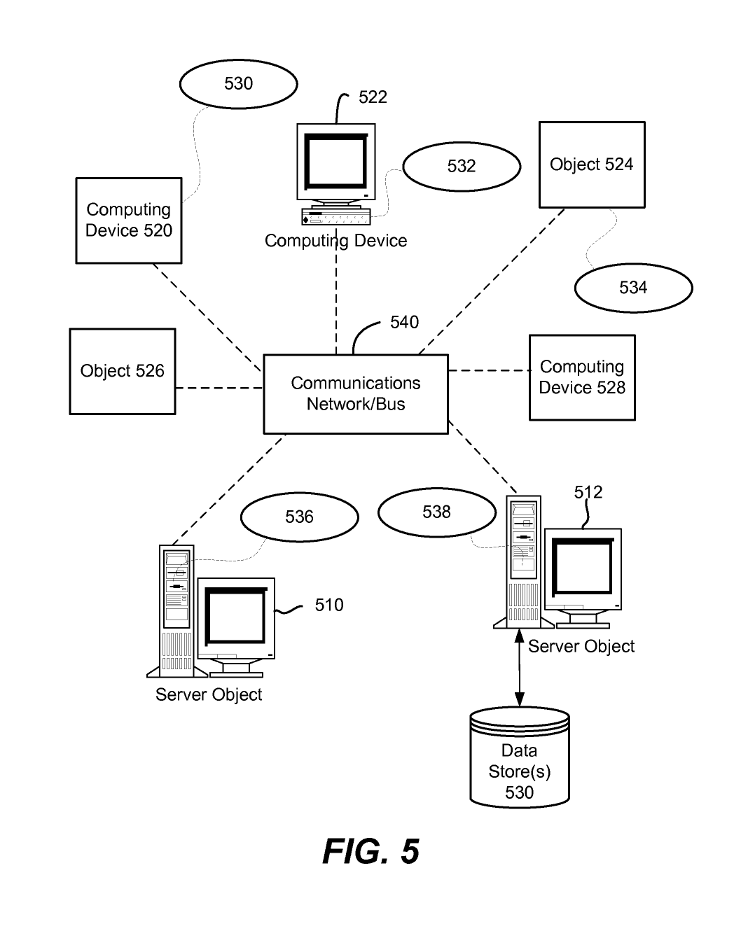

FIG. 5 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Example Computing Device

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

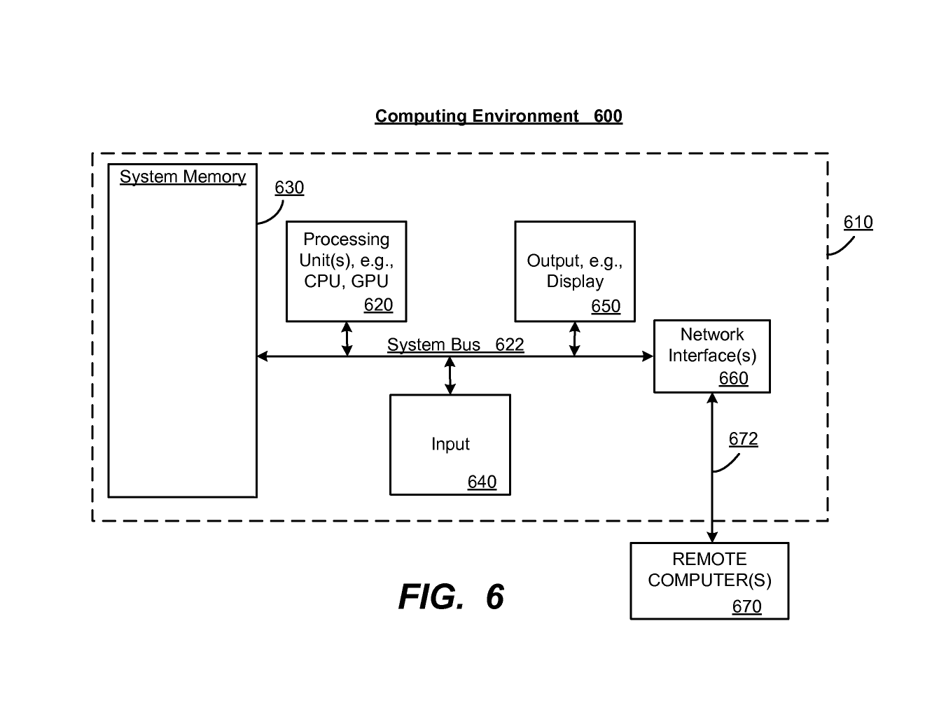

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, ranking electronic documents in sub-linear time complexity, including, for each of at least one random walk round, navigating the electronic documents via embedded links from a starting document and an ending document that are within a pre-determined distance, providing an estimate of rank contribution information associated with each starting document, and determining an exposure level for at least a portion of the electronic documents based on the estimate of the rank contribution information.

2. The method of claim 1, wherein providing the estimate further comprises computing values for an out-bound contribution vector and an in-bound contribution vector for each electronic document.

3. The method of claim 2 further comprising generating personalized ranking information corresponding to the electronic documents using a portion of the rank contribution information.

4. The method of claim 3, wherein generating the personalized ranking information further comprises computing a sum of a portion of the inbound contribution vector.

5. The method of claim 3, wherein generating the personalized ranking information further comprises extracting a sample of in-bound contribution vector values associated with a particular electronic document and using the sample to generate a ranking value within an approximation factor, wherein the approximation corresponds to an additive error and a multiplicative error.

6. The method of claim 5, wherein extracting the sample further comprises partitioning the in-bound rank contribution values into chunks and identifying a chunk having at least one rank contribution value in excess of a pre-defined ranking value threshold.

7. The method of claim 3, wherein generating the personalized ranking information further comprises identifying a set of electronic documents, wherein each electronic document having a ranking value that exceeds a threshold.

8. The method of claim 1, wherein determining the exposure level further comprises selecting an uncovered electronic document having an in-degree with respect to coverage within a network that exceeds an in-degree threshold and transforming the uncovered electronic document into a covered electronic document.

9. The method of claim 8, wherein selecting the uncovered electronic document further comprising marking electronic documents traversed during each random walk round.

10. The method of claim 1, wherein navigating the electronic documents further comprises after each random walk round, returning to the starting node if the random walk round distance exceeds the pre-determined distance.

11. The method of claim 1, wherein determining the exposure level further comprising selecting a set of electronic entities to maximize exposure of an advertisement.

12. The method of claim 1, wherein providing the estimate of the rank contribution information further comprises providing the pre-determined distance based on a termination probability and at least one mathematical approximation factor.

13. The method of claim 1, wherein providing the estimate of the rank contribution information further comprises returning to the starting node if a random walk round distance exceeds the pre-determined distance.

14. In a computing environment, a system, comprising, a ranking mechanism configured to estimate in-degrees within an acceptable approximation range, in sub-linear time, for electronic entities of an Internet resource, wherein the ranking mechanism is further configured to simulate random walks across the electronic entities via out-bound links with a pre-defined termination probability and for at most a length, to determine exposure levels for the electronic entities having at least a threshold number of in-bound links, and to identify a set of electronic entities that maximize exposure to other electronic entities associated with the Internet resource.

15. The system of claim 14 further comprising an advertising provider for selecting the set of electronic entities to publish an advertisement on an electronic document associated with the social network.

16. The system of claim 14, wherein the ranking mechanism computes a maximum in-degree within the social network and a threshold number of in-bound links based on the maximum in-degree.

17. The system of claim 14, wherein the ranking mechanism determines the length based on the pre-defined termination probability and at least one mathematical approximation factor.

18. One or more computer-readable media having computer-executable instructions, which when executed perform steps, comprising:
generating a graph representing a social and informational network and comprising a plurality of nodes, wherein each node represents an network user;
traversing the graph with a termination probability and a length to generate one or more adjacency lists for at least a portion of the plurality of nodes;
extracting a sample of the one or more adjacency lists to estimate in-degrees, within an acceptable approximation, for the at least a portion of the plurality of nodes; and
selecting a set of nodes to expose an advertisement based on the in-degrees.

19. The one or more computer-readable media of claim 18 having further computer-executable instructions comprising:
identifying the set of nodes having a highest in-degree sum amongst the plurality of nodes.

20. The one or more computer-readable media of claim 18 having further computer-executable instructions comprising:
identifying the set of nodes having a highest in-degree coverage amongst the plurality of nodes.
